(19) United States
(12) Patent Application Publication
(10) Pub. No.: US 2024/0346491 A1
(43) Pub. Date: Oct. 17, 2024

(54) SUSTAINABLE MONETARY SYSTEM AND METHODS

(71) Applicant: Daniel Weitmann, Stockholm (SE)

(72) Inventor: Daniel Weitmann, Stockholm (SE)

(21) Appl. No.: 18/134,779

(22) Filed: Apr. 14, 2023

(51) Int. Cl. G06Q 20/38; G06Q 20/08

(52) U.S. Cl. CPC G06Q 20/381; G06Q 20/0855; G06Q 20/389

(57) ABSTRACT

A computer implemented sustainable monetary system may include; a plurality of Indivisible Physical Identifiable Currency Units (IPICUs), in which each IPICU has an identifier, and each identifier is unique to each IPICU; a digital ledger stored in one or more computer-readable data stores, in which the digital ledger includes a plurality of unit accounts; program instructions stored in one or more computer-readable memories; and one or more processors configured to execute the program instructions to cause the system to perform operations which include: administering the plurality of unit accounts, each of which belongs to one or more account owners, in which each identifier is associated with a single unit account at any given point in time. Preferably, the identifier of each IPICU may be physically affixed to that IPICU. Preferably, at least one, and more preferably each, IPICU is a gold bullion coin or a gold bullion bar.

### FIELD OF THE INVENTION

This patent specification relates to the field of alternative banking, alternative currency, and alternative payment systems. More specifically, this patent specification relates to a sustainable monetary system and methods which include the utilization of identifiable indivisible physical currency units that are recorded as the account holder's private property, and transferable on open and closed global payments networks.

### BACKGROUND

Regarding the sustainability of the Banking system, central banking systems and currencies, there are several reasons why the current banking system, central banking systems, and currencies may be considered unsustainable in the long run.

Firstly, the current banking system is based on a debt-based monetary system, which means that money is created through loans and other forms of debt. This can lead to a cycle of debt and financial instability, particularly in times of economic downturn. Additionally, the interest paid on debt creates an ever-increasing burden on the economy, which can lead to inflation and devaluation of the currency.

Secondly, the current central banking system is based on a model of monetary policy that relies heavily on interest rate manipulation and quantitative easing, which can distort the economy and create a number of unintended consequences. For example, low interest rates can encourage excessive borrowing and risk-taking, while high interest rates can lead to economic contraction and deflation.

Thirdly, the current banking system and currencies are often subject to geopolitical tensions, which can create volatility and uncertainty in the financial markets. In particular, the dominance of the US dollar as the world's reserve currency has been a source of concern for some, as it can create vulnerabilities in the global financial system.

Finally, the current banking system and currencies are often criticized for their lack of transparency and accountability. Many financial institutions operate in complex and opaque ways, which can make it difficult for consumers and regulators to understand and monitor their activities. This can create risks of fraud, corruption, and financial instability.

Overall, these factors contribute to a banking system, central banking systems, and currencies that may be considered unsustainable in the long run. While the current system has provided stability and growth in the past, there are increasing concerns about its ability to adapt to changing economic, technological, and geopolitical conditions.

### Banking Systems

### Problems with Central Banking in General

Central banks have been facing challenges with the creditworthiness of governments, particularly in times of economic crisis or political instability. The creditworthiness of a government refers to its ability to pay back its debts and meet its financial obligations. When a government's creditworthiness is questioned, it can lead to a decrease in confidence from investors, which can in turn lead to higher borrowing costs and even default. Central banks have the responsibility to maintain stability in the financial system, but the creditworthiness of governments can present a significant challenge to their ability to do so.

Central banking has several flaws that have been identified by economists and policymakers. One major flaw is that central banks have limited control over the economy, despite their efforts to use monetary policy to stabilize it. In particular, central banks face significant challenges in accurately predicting economic trends and adjusting interest rates and other policy levers accordingly. This can lead to unintended consequences, such as inflation or deflation, that can have negative impacts on the economy.

Another flaw of central banking is that it can lead to moral hazard, where banks and other financial institutions take on excessive risk because they believe that the central bank will bail them out if they run into trouble. This can lead to instability in the financial system and can ultimately result in taxpayer-funded bailouts.

Central banking also tends to be highly politicized, with central banks often being subject to political pressure from elected officials and other interest groups. This can make it difficult for central banks to pursue independent monetary policy that is in the best interests of the economy as a whole.

### Problems with Banking Systems in General

The current banking system is largely controlled by a small number of large financial institutions, which can exert significant influence over the economy and financial markets. This can limit competition and innovation, and may lead to an unequal distribution of wealth and power.

The unsustainable current banking model, as referred to in BASEL III, is characterized by excessive risk-taking, inadequate capital buffers, and a lack of proper risk management systems. This model has been criticized for contributing to the 2008 financial crisis and for creating systemic risks that threaten the stability of the global financial system. In response, BASEL III introduced a set of regulations that aim to promote financial stability by requiring banks to maintain higher capital ratios, adopt more robust risk management practices, and reduce their reliance on short-term funding sources. However, some critics argue that these measures may not be sufficient to address the underlying problems of the banking system and that more fundamental reforms are needed to create a sustainable and resilient financial system.

Excessive risk-taking: The current banking system encourages excessive risk-taking by providing incentives for banks to make risky loans and investments. This can lead to financial instability and systemic risks that threaten the stability of the global financial system.

Inadequate capital buffers: Banks are required to maintain a minimum level of capital to absorb losses, but this level may not be sufficient to cover unexpected losses. This can lead to bank failures and financial crises.

Lack of proper risk management systems: Many banks have inadequate risk management systems that fail to identify and mitigate risks. This can result in large losses that can destabilize the bank and the financial system as a whole.

Centralized control of the money supply: The current currency system is centralized and controlled by central banks. This can lead to inflation, currency devaluation, and loss of confidence in the currency.

Vulnerability to cyber-attacks: The current banking and currency systems are vulnerable to cyber-attacks that can disrupt the financial system and compromise the security of customer accounts.

Limited access: The current banking and currency systems are not accessible to all individuals and communities, particularly those in developing countries or marginalized populations.

Lack of transparency: The current banking and currency systems lack transparency, making it difficult for customers to understand the fees and charges associated with banking services and currency exchange rates.

### Problems with the Bank for International Settlements (BIS)

The Bank for International Settlements (BIS) is a global organization that was established to promote international monetary and financial stability. While the BIS has played an important role in coordinating global financial policy, it also has several flaws that have been the subject of criticism.

One major criticism of the BIS is that it is largely controlled by the central banks of its member countries, which can make it difficult to achieve consensus on important issues. This can lead to delays and inefficiencies in decision-making, and can limit the ability of the organization to respond quickly to emerging financial challenges.

Another criticism of the BIS is that it has been accused of being overly secretive and lacking transparency in its decision-making processes. This has led to concerns that the organization may not be fully accountable to the public or to its member countries.

In addition, the BIS has been criticized for its perceived bias toward the interests of developed countries and large financial institutions. Some observers have argued that the organization is not doing enough to address the needs of developing countries, which may be more vulnerable to financial instability and crises.

Finally, some critics have raised concerns about the BIS's ability to effectively regulate the global financial system. While the organization has made significant efforts to promote financial stability, some argue that it lacks the necessary authority and resources to effectively monitor and regulate the activities of large financial institutions.

### Payment Systems

### Problems with the Payments systems in General

There are several payment systems in the world, These systems include, SWIFT (Society for Worldwide Interbank Financial Telecommunication), Fedwire, CHIPS (Clearing House Interbank Payments System), TARGET2 (Trans-European Automated Real-time Gross Settlement Express Transfer System), SEPA (Single Euro Payments Area): SEPA is a payment integration initiative that enables euro-denominated payments to be made across the European Union and European Economic Area, ACH (Automated Clearing House): ACH is a payment system that enables electronic transactions, including direct deposits and bill payments, to be processed in batches, Faster Payments: Faster Payments is a UK payment system that enables near-instant transfers between bank accounts, BACS (Bankers' Automated Clearing Services, Zengin System, China National Advanced Payment System (CNAPS, UnionPay, WeChat Pay and Alipay, The Russian Mir payment system.

Intermediary risk: Payment systems can be inefficient and contribute to credit risk in several ways. One major factor is that payment systems often rely on intermediaries, such as banks and other financial institutions, which can create additional costs and delays in the payment process. These intermediaries often charge fees for their services, which can add up and make payments more expensive for consumers and businesses.

Excessive borrowing: Furthermore, payment systems can contribute to credit risk by enabling excessive borrowing and risk-taking. For example, if credit is easily accessible and interest rates are low, borrowers may be more inclined to take on more debt than they can reasonably manage. This can lead to a cycle of borrowing, which can fuel economic growth in the short term but create vulnerabilities in the long term.

False security: In addition, payment systems can contribute to credit risk by creating a false sense of security among borrowers and lenders. When payment systems are functioning smoothly and transactions are processed quickly and reliably, it can be easy to overlook the underlying risks of lending and borrowing. This can lead to a situation where credit is extended too freely and borrowers are unable to repay their debts, which can trigger a credit crisis.

Slow processing times: transfers can take several days to complete, which can cause delays and frustration for customers.

High transaction costs: transfers can be expensive, particularly for smaller transactions. The fees charged by banks can be high, and the exchange rate used may not be favorable to the customer.

Limited transparency: The systems lack transparency, and customers may not have visibility into the fees and charges associated with their transfers.

Limited accessibility: The systems are not accessible to all individuals and businesses, particularly those in developing countries or marginalized populations.

Lack of real-time tracking: The systems do not provide real-time tracking of transfers, which can make it difficult for customers to monitor the progress of their transfers.

Vulnerability to cyber-attacks: The systems have been subject to several high-profile cyber-attacks in recent years, which can compromise the security of customer accounts and disrupt the financial system.

Limited interoperability: The systems may not be compatible with other payment systems, which can make cross-border transfers more difficult and expensive.

### Problems with Alternative Payment Systems

Alternative payment systems, include PayPal, Stripe, Square, Venmo, Apple Pay, Google Pay, Amazon Pay, Skrill, Neteller, Alipay, WeChat Pay, Zelle, TransferWise, Payoneer, BitPay (for Bitcoin payments)

First, alternative payment systems can create credit risk if they are used to extend credit to consumers and businesses. For example, if a payment system provider allows users to make purchases using funds that they do not currently have, this can create a credit risk for the provider if users are unable to pay back the borrowed funds. This risk can be particularly significant if the payment system provider is not regulated or subject to the same level of oversight as traditional financial institutions.

Second, the use of alternative payment systems can contribute to inflation if they are used to create new forms of currency. For example, cryptocurrencies such as Bitcoin and Ethereum are designed to be decentralized and not subject to government control. While this can offer certain benefits, such as increased privacy and security, it also means that these currencies can be subject to inflation if there is an oversupply of them in the market. This can lead to a loss of value and purchasing power for users who hold these currencies.

Finally, alternative payment systems can contribute to inflation if they are subject to higher fees and commissions than traditional payment systems. If these fees are passed on to consumers and businesses in the form of higher prices, this can contribute to inflationary pressures in the economy.

### Currencies

### Problems Caused by Fiat Currencies

Fiat currencies, or currencies that are not backed by a physical commodity such as gold, have been the norm in most countries since the 1970s. While they have provided governments with greater flexibility in managing their economies, fiat currencies have also been associated with a range of economic problems. In this review of the literature, we summarize the major problems caused by fiat currencies.

First, fiat currencies can be subject to inflationary pressures. Governments can create new money through central bank lending, which can lead to an increase in the money supply and a corresponding decrease in the value of the currency. Second, fiat currencies can lead to economic instability, as governments may manipulate interest rates and the money supply to meet political objectives rather than economic goals. This can lead to bubbles and financial crises.

Third, fiat currencies can have negative impacts on international trade. As the value of fiat currencies fluctuate, it can be difficult for businesses to plan for the future and make investments. Fourth, fiat currencies can undermine the stability of financial institutions. Inflation and economic instability can lead to bank failures and bailouts, which can have broader impacts on the economy.

Finally, fiat currencies can have social and environmental consequences. Governments may use inflation as a way to transfer wealth from the poor to the rich, and the economic instability caused by fiat currencies can have negative impacts on the environment.

In conclusion, while fiat currencies have provided governments with greater flexibility in managing their economies, they have also been associated with a range of economic, social, and environmental problems. Future research should focus on identifying policies and institutions that can mitigate these problems and promote greater economic stability and sustainability.

### Problems and Risks with Alternative Currencies

Alternative currencies, such as Bitcoin, other cryptocurrencies, and stable coins, have gained increasing attention and popularity in recent years. However, they also pose several risks and problems that need to be considered.

One major problem is that they lack regulation and oversight, which makes them vulnerable to fraud, hacking, and other security threats. This can result in significant losses for users who store their assets in these currencies. Additionally, the lack of regulation and oversight can create a fertile ground for criminal activity, such as money laundering and terrorism financing.

Another problem is that alternative currencies can be highly volatile. The value of cryptocurrencies can fluctuate dramatically in short periods of time, which can make them difficult to use as a stable store of value. This volatility can also make them unsuitable as a means of payment, as merchants and other businesses may be reluctant to accept them due to their unpredictable value.

Furthermore, alternative currencies are not widely accepted and are often difficult to exchange for traditional currencies. This can make it challenging for individuals and businesses to use these currencies in everyday transactions, which limits their usefulness.

Stable coins, which are designed to maintain a stable value relative to traditional currencies, have also been subject to criticism. One issue is that they rely on centralized entities to maintain the stability of the currency, which can create counterparty risks if these entities fail or become insolvent.

### Global Currency

Discussions around the creation of a global currency have been ongoing for decades, and the concept has both supporters and detractors. Proponents argue that a global currency could offer several benefits, including increased financial stability, reduced exchange rate volatility, and improved international trade.

One potential benefit of a global currency is the ability to reduce exchange rate volatility. With a single currency, there would be no need for currency exchange transactions, which can be subject to fluctuations in value. This could lead to more stable trade relationships and potentially reduce the risk of financial crises.

A global currency could also help to reduce the risks associated with currency manipulation. Currently, some countries manipulate their currencies to gain a competitive advantage in international trade, which can have negative consequences for other countries. With a global currency, this type of manipulation would be eliminated, which could help to level the playing field for all countries.

Another potential benefit of a global currency is the ability to improve international trade. With a single currency, it would be easier for businesses to conduct transactions across borders, which could lead to increased trade and economic growth. This could be particularly beneficial for developing countries, which currently face significant barriers to participating in the global economy.

However, there are also several potential drawbacks to a global currency. One concern is that it could be subject to political influence, which could undermine its value and stability. Additionally, there would be significant practical challenges to creating and implementing a global currency, including issues related to governance, regulation, and infrastructure.

### Gold as a Global Currency

Gold has been used as a currency for thousands of years and has long been considered a store of value and a safe haven asset. In recent years, there has been increasing discussion about the potential of gold as a global currency. In this review of the literature, we summarize the advantages and limitations of gold as a global currency.

First, gold is a limited resource, which means that its value is less susceptible to inflationary pressures. It also has a long history of being considered a safe haven asset, which means that it can provide a stable store of value during times of economic uncertainty. Second, gold is a universally recognized currency, which means that it can be easily traded and accepted across borders and cultures.

However, there are also several limitations to using gold as a global currency. First, gold is a physical asset, which means that it can be difficult and costly to transport and store. Second, the supply of gold is limited, which means that it may not be able to meet the needs of a growing global economy. Third, the price of gold can be volatile, which can make it difficult to use as a stable currency.

In conclusion, while gold has many advantages as a global currency, it also has several limitations that need to be carefully considered. Future research should focus on identifying ways to address these limitations and explore the potential of gold as a global currency in the context of a rapidly changing global economy.

Therefore, a need exists for novel computer-implemented sustainable monetary systems and methods.

### BRIEF SUMMARY OF THE INVENTION

According to one embodiment consistent with the principles of the invention, a computer implemented sustainable monetary system is provided. The sustainable monetary system preferably utilizes indivisible physical identifiable currency units that may be legal tender physical metal currency units and that are registered and transferred between account owners to provide an alternative to traditional fiat currency and banking systems. The sustainable monetary system aims to address issues of inflation, currency risk, and bank risk by providing a universally accepted currency that retains its value permanently and serves as a non-alterable unit of account and medium of exchange with instant transactions over a publicly available network.

In some embodiments, the system may include; a plurality of Indivisible Physical Identifiable Currency Units (IPICUs), in which each IPICU has an identifier, and each identifier is unique to each IPICU; a digital ledger stored in one or more computer-readable data stores, in which the digital ledger includes a plurality of unit accounts; program instructions stored in one or more computer-readable memories; and one or more processors configured to execute the program instructions to cause the system to perform operations which include: administering the plurality of unit accounts, each of which belongs to one or more account owners, in which each identifier is associated with a single unit account at any given point in time. Preferably, the identifier of each Indivisible Physical Identifiable Currency Unit may be physically affixed to that Indivisible Physical Identifiable Currency Unit. Preferably, at least one, and more preferably each, Indivisible Physical Identifiable Currency Unit is a gold bullion coin or a gold bullion bar.

In further embodiments, the system may execute program instructions to cause the system to perform operations that include: receiving incoming payment information for a user unit account from a payment network, the incoming payment information having an incoming amount of a fiat currency from a third party financial institution; crediting a system fiat settlement account with the incoming amount of a fiat currency; determining an exchange rate, the exchange rate describing a number of Indivisible Physical Identifiable Currency Units having a value equal to the incoming amount of the fiat currency based on an exchange rate between the fiat currency and Indivisible Physical Identifiable Currency Units; and transferring ownership of a number of Indivisible Physical Identifiable Currency Units, the number equal to the exchange rate, from a system unit account to the user unit account by generating a transaction record in the digital ledger, in which the transaction record simultaneously disassociates the identifiers of the number of Indivisible Physical Identifiable Currency Units from the system unit account and associates the identifiers of number of Indivisible Physical Identifiable Currency Units with the user unit account.

In further embodiments, the system may execute program instructions to cause the system to perform operations that include: receiving outgoing payment information for a user unit account, the outgoing payment information having an outgoing amount of a fiat currency and an account of a third-party financial institution that is to be credited with the outgoing amount of a fiat currency; determining an exchange rate, the exchange rate describing a number of Indivisible Physical Identifiable Currency Units having a value equal to the outgoing amount of the fiat currency based on an exchange rate between the fiat currency and Indivisible Physical Identifiable Currency Units; transferring ownership of a number of Indivisible Physical Identifiable Currency Units, the number equal to the exchange rate, from the user unit account to a system unit account by generating a transaction record in the digital ledger, in which the transaction record simultaneously disassociates the identifiers of the number of Indivisible Physical Identifiable Currency Units from the user unit account and associates the identifiers of number of Indivisible Physical Identifiable Currency Units with the system unit account; and debiting the outgoing amount of the fiat currency from a system fiat settlement account and crediting the outgoing amount of the fiat currency to the third-party financial institution.

In further embodiments, the system may execute program instructions to cause the system to perform operations that include: receiving transfer payment information, the transfer payment information having a number of Indivisible Physical Identifiable Currency Units that are to be transferred from a first user unit account of a first user account owner to a second user unit account of a second user account owner; selecting identifiers of one or more Indivisible Physical Identifiable Currency Units, equal to the number of Indivisible Physical Identifiable Currency Units in the transfer payment information, that are to be transferred from the first user unit account of the first user account owner to the second user unit account of the second user account owner; and transferring ownership of the one or more Indivisible Physical Identifiable Currency Units from the first user unit account to the second user unit account by generating a transaction record in the digital ledger, wherein the transaction record simultaneously disassociates the one or more identifiers from the first user unit account and associates the one or more identifiers with the second user unit account.

In further embodiments, the system may execute program instructions to cause the system to perform operations that include: receiving outgoing payment information for a user unit account of an account owner, the outgoing payment information having an outgoing amount of a fiat currency and a credit card account, of a third-party financial institution, owned by the account owner that is to be credited with the outgoing amount of a fiat currency; determining an exchange rate, the exchange rate describing a number of Indivisible Physical Identifiable Currency Units having a value equal to the outgoing amount of the fiat currency based on an exchange rate between the fiat currency and Indivisible Physical Identifiable Currency Units; transferring ownership of a number of Indivisible Physical Identifiable Currency Units, the number equal to the exchange rate, from the user unit account to a system unit account by generating a transaction record in the digital ledger, in which the transaction record simultaneously disassociates the identifiers of the number of Indivisible Physical Identifiable Currency Units from the user unit account and associates the identifiers of number of Indivisible Physical Identifiable Currency Units with the system unit account; and debiting the outgoing amount of the fiat currency from a system fiat settlement account and crediting the outgoing amount of the fiat currency to the third-party financial institution.

In further embodiments, the system may execute program instructions to cause the system to perform operations that include: receiving incoming payment information for a user unit account of a user account owner from a client device of the user account owner, the incoming payment information having an incoming amount of a fiat currency to be debited from a banking account of the account owner at a banking institution type of third party financial institution; crediting a system fiat settlement account with the incoming amount of a fiat currency; determining an exchange rate, the exchange rate describing a number of Indivisible Physical Identifiable Currency Units having a value equal to the amount of a fiat currency based on an exchange rate between the fiat currency and Indivisible Physical Identifiable Currency Units; and transferring ownership of a number of Indivisible Physical Identifiable Currency Units, the number equal to the exchange rate, from a system unit account to the user unit account by generating a transaction record in the digital ledger, in which the transaction record simultaneously disassociates the identifiers of the number of Indivisible Physical Identifiable Currency Units from the system unit account and associates the identifiers of number of Indivisible Physical Identifiable Currency Units with the user unit account.

In further embodiments, the system may execute program instructions to cause the system to perform operations that include: receiving outgoing payment information for a user unit account of a user account owner, the outgoing payment information having an outgoing amount of a fiat currency that is to be credited to a banking account of the user account owner at a banking institution type of third party financial institution; determining an exchange rate, the exchange rate describing a number of Indivisible Physical Identifiable Currency Units having a value equal to the outgoing amount of the fiat currency based on an exchange rate between the fiat currency and Indivisible Physical Identifiable Currency Units; transferring ownership of a number of Indivisible Physical Identifiable Currency Units, the number equal to the exchange rate, from the user unit account to a system unit account by generating a transaction record in the digital ledger, in which the transaction record simultaneously disassociates the identifiers of the number of Indivisible Physical Identifiable Currency Units from the user unit account and associates the identifiers of number of Indivisible Physical Identifiable Currency Units with the system unit account; and debiting the outgoing amount of the fiat currency from a system fiat settlement account and crediting the outgoing amount of the fiat currency to the banking institution type of third party financial institution.

Numerous objects, features and advantages of the present invention will be readily apparent to those of ordinary skill in the art. Some example objects of the present invention are listed below.

One object of the present invention is to provide a sustainable monetary system that is configured to be integrated with existing financial systems, allowing for seamless transfer of funds between the IPICUs 130 and fiat currencies. This integration helps to reduce the cost and complexity of transactions, while also providing greater security and stability to the financial system.

Another object of the present invention is to provide a sustainable monetary system having increased transparency and accountability. The use of IPICUs, along with the AML and KYC screening requirements, increases transparency and accountability in financial transactions. This helps to prevent illicit activities, such as money laundering and financing of terrorism, while also promoting a more sustainable and ethical financial system.

Another object of the present invention is to provide a sustainable monetary system having potential for increased financial inclusion. The use of IPICUs can help to increase financial inclusion, particularly for individuals and communities that may not have access to traditional banking services. This can promote greater economic growth and stability, while also reducing poverty and inequality.

Another object of the present invention is to provide a sustainable monetary system having reduced risk of inflation and currency devaluation: The use of a stable, physical commodity like gold as the basis for the IPICUs can help to reduce the risk of inflation and currency devaluation, which can destabilize economies and undermine confidence in financial systems.

Another object of the present invention is to provide a sustainable monetary system having increased sustainability over existing systems. The use of IPICUs based on gold and other precious metals can promote greater financial stability and resilience, while also encouraging more responsible and sustainable economic practices. This can help to mitigate the impact of financial crises and promote long-term economic growth and prosperity.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an illustrative example of some of the components and computer implemented methods which may be found in a sustainable monetary system according to various embodiments described herein.

FIG. 2 illustrates a block diagram showing an example of a server which may be used by the system as described in various embodiments herein.

FIG. 3 shows a block diagram illustrating an example of a client device which may be used by the system as described in various embodiments herein.

FIG. 4 depicts a block diagram illustrating an example of a system database according to various embodiments described herein.

FIG. 5 illustrates a block diagram of an example of a computer-implemented method for real-time processing of incoming payments in fiat currency from an open payment network, a closed payment network, a third party financial institution, or other payment source, and converting the incoming payments to IPICUs that may be added to a unit account according to various embodiments described herein.

FIG. 6 shows a block diagram of an example of a computer-implemented method for real-time processing of authorized outgoing payments in fiat currency over an open payment network, a closed payment network, a third party financial institution, or other payment destination, and settling the payment amount from a user account holder's or owner's user unit account.

FIG. 7 depicts a block diagram of an example of a computer-implemented method for real-time processing of authorized transfers of IPICUs between the unit accounts of two or more account owners according to various embodiments described herein.

FIG. 8 illustrates a block diagram of an example of a computer-implemented method for real-time processing of authorized payment of a user account owner's sale of one or more IPICUs, and paying them out to a credit card account, of a third party financial institution, owned by the user account owner according to various embodiments described herein.

FIG. 9 shows a block diagram of an example of a computer-implemented method for real-time settlement of a user account owner's purchase of IPICUs with fiat currency from a bank account, of a third party financial institution, owned by the user account owner according to various embodiments described herein.

FIG. 10 depicts a block diagram of an example of a computer-implemented method for real-time settlement of user account owner's sale of IPICUs with a banking account, of a third party financial institution, owned by the user account owner according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 15% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, the terms “computer” and “computing device” refer to a machine, apparatus, or device that is capable of accepting and performing logic operations from software code. The term “application”, “software”, “software code”, “source code”, “script”, or “computer software” refers to any set of instructions operable to cause a computer to perform an operation. Software code may be operated on by a “rules engine” or processor. Thus, the methods and systems of the present invention may be performed by a computer or computing device having a processor based on instructions received by computer applications and software, with servers and client devices comprising exemplary computing devices.

The term “client device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of client devices include: personal computers (PCs), workstations, servers, laptops, tablet PCs including the iPad, cell phones including iOS phones made by Apple Inc., Android OS phones, Microsoft OS phones, Blackberry phones, Apple iPads, Anota digital pens, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, tablets, digital pens, wearable computers such as Apple Watch, other smartwatches, Fitbit, other wearable fitness trackers, Google Glasses, and the like.

The terms “computer readable medium” and “computer readable memory” as used herein refers to any medium that participates in providing instructions to a processor for execution and/or participates in storing data which may be used by a processor. A computer readable medium or memory may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as client devices either using wires or wirelessly allowing them to transmit and receive data. Non-limiting examples of data networks may include the internet or wireless networks or (i.e., a “wireless network”) which may include Wi-Fi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, a Zigbee network, or a voice-over-IP (VOIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a client device through the internet (i.e., the database is in the cloud) or alternatively in some embodiments the database may be stored on the client device or remote computer itself (i.e., local storage). A “data store” as used herein may contain or comprise a database (i.e., information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New computer-implemented Sustainable Monetary systems and methods are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

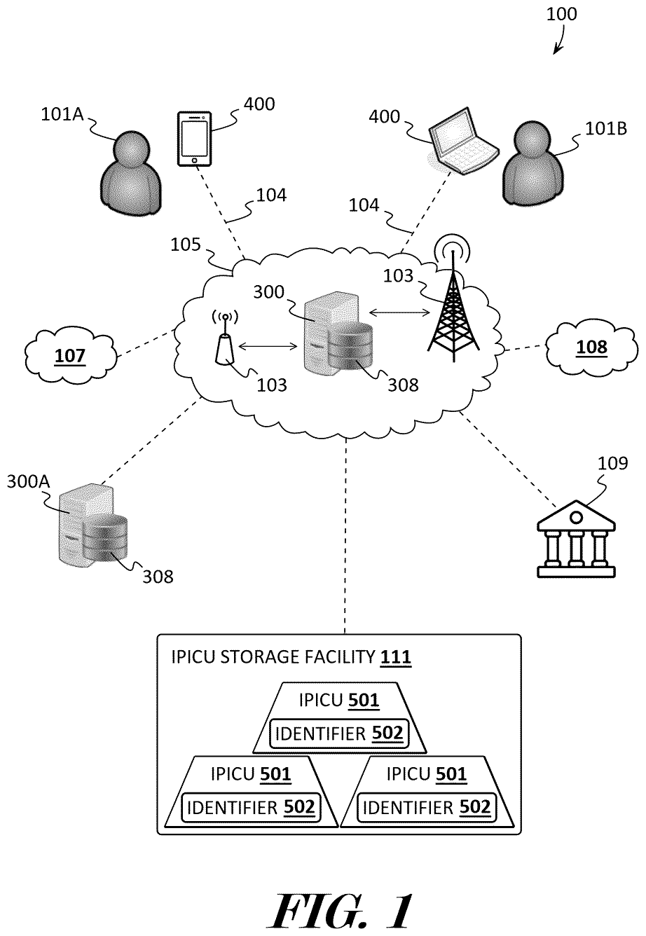

The present invention will now be described by example and through referencing the appended figures representing preferred and alternative embodiments. As perhaps best shown by FIG. 1, an illustrative example of some of the physical components which may comprise a sustainable monetary system (“the system”) 100 according to some embodiments is presented. The system 100 is configured to facilitate the transfer of data and information between one or more account owners, such as user account owners 101A and system account owner 101B, open payment networks 107, closed payment networks 108, third party financial institutions 109, and indivisible physical identifiable currency unit storage facilities 111 via client devices 400 and servers 300, 300A, over a data network 105. Client devices 400 and servers 300, 300A, may send data to and receive data from the data network 105 through a network connection 104 with an access point 103. One or more data stores 308 accessible by a server 300, 300A, may contain one or more system databases 120. The data may comprise any information input into the system 100, including: information on or describing one or more account owners 101A, 101B, open payment networks 107, closed payment networks 108, third party financial institutions 109, and indivisible physical identifiable currency unit storage facilities 111, information on or describing indivisible physical identifiable currency units 130 and their respective identifiers 131, information on or describing fiat currency paid into and out of the system 100, information on or describing transactions involving indivisible physical identifiable currency units 130, and information on or describing transactions involving fiat currency, and any other data and information described herein.

Client devices 400 and servers 300, 300A, may enable system 100 data exchange between account owners 101A, 101B, open payment networks 107, closed payment networks 108, third party financial institutions 109, and indivisible physical identifiable currency unit storage facilities 111. In this example, the system 100 comprises at least one client device 400 (but preferably more than two client devices 400) configured to be operated by one or more account owners 101A, 101B, and optionally operated by one or more open payment networks 107, closed payment networks 108, third party financial institutions 109, and indivisible physical identifiable currency unit storage facilities 111. Client devices 400 may include mobile devices, such as laptops, tablet computers, personal digital assistants, smart phones, and the like, that are equipped with a wireless network interface capable of sending data to one or more servers 300, 300A, with access to one or more data stores 308 over a network 105, such as a wireless local area network (WLAN). Additionally, client devices 400 may include fixed devices, such as desktops, workstations, and the like, that are equipped with a wireless or wired network interface capable of sending data to one or more servers 300, 300A, with access to one or more data stores 308 over a wireless or wired local area network 105. The present invention may be implemented on at least one computing device, such as a client device 400 and/or server 300, 300A, programmed to perform one or more of the steps described herein. In some embodiments, more than one client device 400 and/or server 300, 300A, may be used, with each being programmed to carry out one or more steps of a method or process described herein.

The system 100 may comprise a plurality of Indivisible Physical Identifiable Currency Units (“IPICUs”) 130 which the system 100 may use as its underlying currency. In preferred embodiments, one or more, and more preferably each, IPICUs 130 may comprise a gold bullion coin and/or a gold bullion bar. In further embodiments, one or more IPICUs 130 may comprise a silver bullion coin, a silver bullion bar, a platinum bullion coin, a platinum bullion bar, or any other type of precious metal or semi-precious metal bar, coin, or other form. For example, one or more IPICUs 130 may comprise legal tender physical gold and silver bullion coins, such as 1 Oz American Eagles (50 USD and 1 USD), 1 Oz Britannia (100 GBP and 1 GBP), 1 Oz Austrian Philharmonic (100 EUR and 1 EUR), and Swiss 20 fr Vrenelli in gold. In further preferred embodiments, each, IPICU 130 may comprise physical gold that is vaulted and secured and registered as private property of a single account holder or account owner 101A, 101B. In further preferred embodiments, each, IPICU 130 may comprise physical gold, such as 1 Oz gold bullion coins and bars.

Each IPICU 130 of the system 100 may comprise an identifier 131 that is unique to that IPICU 130. Generally, an identifier 131 may comprise a serial number or unique identifier assigned incrementally or sequentially to an item, to uniquely identify it. An identifier 131 may comprise any type of human or computer read-able code. For example, an identifier 131 may comprise typographical symbols, an alpha and/or numeric string of characters, a bar code such as a linear barcode, a matrix barcode, a QR code, etc. In preferred embodiments, each IPICU 130 may comprise an identifier 131 that may be physically affixed to that IPICU 130 to reasonably prevent identifiers 131 from being separated or removed from their respective IPICUs 130. For example, an identifier 131 may be physically affixed to a IPICU 130 by being imprinted, stamped, etched, carved, or engraved into the IPICU 130, or by being printed or otherwise into a substrate that is in turn bonded to a IPICU 130, by being coded onto a Near-field communication (NFC) chip, radio-frequency identification (RFID) chip, etc. that is in turn bonded to a IPICU 130, or by any other suitable device or method.

The system 100 may comprise one or more indivisible physical identifiable currency unit storage facilities 111 which may store and secure one or more IPICUs 130 of the system 100. Indivisible physical identifiable currency unit storage facilities 111 may comprise any type of secure storage facility, such as a bank, bank vault, other vaulted location, etc. Preferably, IPICUs 130 may be transferred between indivisible physical identifiable currency unit storage facilities 111 and optionally transferred into and out of indivisible physical identifiable currency unit storage facilities 111 via a transfer network provided by the system 100 that includes security features that ensure that all transfers are secure and protected. This includes secure communication channels, data encryption, and authentication protocols.

The system 100 may be in communication with one or more open payment networks 107, closed payment networks 108, and third party financial institutions 109 so that one or more financial transactions may be completed between account owners 101A, 101B, and the one or more open payment networks 107, closed payment networks 108, and third party financial institutions 109. Typically, Open Loop Systems or open payment networks 107 are available broadly across financial institutions, while Closed Loop Systems or closed payment networks 108 process transactions through a single provider. In a Closed Loop Payment System or closed payment networks 108, both the sender and the receiver need to have an account with a given provider in order to complete payments. Third party financial institutions 109 may include banks, credit unions, insurance companies, credit card companies, investment companies, or any other financial institution capable of performing financial and other types of transactions.

Generally, the system 100 may enable incoming and outgoing payments on public payment systems, such as open payment networks 107 and closed payment networks 108, for the conversion of IPICUs 130 to fiat currency and vice versa include the following features:

Integration with Public Payment Networks: The system 100 is able to integrate with existing public fiat payment networks. This enables account owners 101A, 101B, to make incoming and outgoing payments using IPICUs 130, which can be seamlessly converted to fiat currency and vice versa.

The system 100 is configured to provide real-time processing, such that the conversion of IPICUs 130 to fiat currency and vice versa happens in real-time. This ensures timely and accurate transaction processing, making it easier for users to conduct their transactions.

The system 100 is configured to provide secure transactions by including security features that ensure that all transactions are secure and protected. This includes secure communication channels, data encryption, and authentication protocols, and following generally accepted banking standards and regulations regarding the processing of payments.

The system 100 is configured to provide flexibility in terms of the currency used for transactions. Account owners 101A, 101B, can use IPICUs 130 and/or fiat currency for incoming and outgoing payments. This makes it easier for account owners 101A, 101B, to transact with each other regardless of their preferred currency.

The system 100 may comprise one or more account owners 101A, 101B, which may comprise individuals and/or entities that may use the system 100 to perform transactions. In preferred embodiments, account owners 101A, 101B, may comprise Qualified Account Holders who have undergone AML (Anti-Money Laundering) and KYC (Know Your Customer) screening includes the following features: Account Owner Registration, AML/KYC Screening, Real-time Verification, and Secure Data Handling.

Account Owner Registration: The system 100 requires all individuals and/or entities to register with the system 100 as account owners 101A, 101B, to participate in the sustainable monetary system 100. During registration, individuals and/or entities are required to provide personal information, such as name, address, and identification documents, which are verified against various databases, such as PEP (Politically Exposed Persons) and sanctions lists.

AML/KYC Screening: The system 100 may include a screening process that verifies all account holders against various databases, such as PEP, sanctions lists, and other financial crime databases. This ensures that all account owners 101A, 101B, are legitimate and comply with AML and KYC regulations.

Real-time Verification: The AML/KYC screening process is conducted in real-time using a system that verifies everyone against all databases. This ensures that all account holders are screened and verified quickly and efficiently.

Secure Data Handling: The system 100 may include security features that ensure that all personal information provided by account owners 101A, 101B, is secure and protected. This includes secure communication channels, data encryption, and authentication protocols.

Overall, the system 100 utilizes account owners 101A, 101B, or registered account holders who have undergone AML/KYC screening, and may provide a secure, efficient, and compliant platform for participation in the sustainable monetary system 100. The real-time verification process ensures that all account owners 101A, 101B, are legitimate and comply with AML and KYC regulations, while the secure data handling features protect personal information from unauthorized access or use.

In preferred embodiments, the system 100 enables and provides for administering a Sustainable Monetary System, and includes a plurality of a IPICUs 130, a digital ledger 144 that registers the IPICU 130 holdings of the account owners 101A, 101B, that are stored in indivisible physical identifiable currency unit storage facilities 111. The system 100 also enables the transmitting of IPICUs 130 both internally (stock-in and stock-out between account owners 101A, 101B, on the platform), and the conversion of IPICUs 130 to fiat currency and vice versa, for incoming and outgoing payments over public fiat payment networks, all of which happen in real time 24 hours a day/7 days a week/365 days a year.

The system's 100 potential macroeconomic and political impact and benefits form an integral component, as the directly administered elements of the system 100 are designed to exert this impact through the described emergence scenario. While the system 100 has been designed with a beneficial path in mind, it cannot prevent financial and economic disruptions in the near term due to the embedded flaws and contradictions of existing systems, nor can it forestall transitional disruptions. The system 100, including both directly administered elements and the broader ramifications, is designed in anticipation of the transitional effects that would inevitably result from its emergence and utilizes them to facilitate commercial success and emergence.

In preferred embodiments, the system 100 is configured to enable the transfer of IPICUs 130 both internally and externally. This means that account owners 101A, 101B, can transfer IPICUs 130 between different account owners 101A, 101B, of the system 100, as well as to external parties. External parties may receive information via a client device 400, such as through SMS, Email, etc., that they have received a transfer, and that they require to register with the system 100 to collect their funds. The system 100 allows for real-time transfer of IPICUs 130. This ensures that transfers are executed quickly and efficiently, without the need for a third-party intermediary or delayed processing times. The system 100 includes security features that ensure that all transfers are secure and protected. This includes secure communication channels, data encryption, and authentication protocols. The system 100 is designed to be user-friendly and intuitive, making it easy for users to transfer IPICUs 130 to other account owners 101A, 101B, of the system 100 or to external parties. Overall, the embodiment of the invention related to the transfer network provides a secure, efficient, and user-friendly platform for the real-time transfer of Indivisible Physical Gold Currency Units between owners on the platform and to external parties.

The system 100 is configured to provide a secure platform for registering the account owners 101A, 101B, the accounts and ownership of Indivisible IPICUs 130, as well as the credit card and bank accounts associated with each account owner 101A, 101B. This ensures that the IPICUs 130 are securely stored and handled during the conversion and transaction processes. The system 100 may include, one or more secure storage facilities or indivisible physical identifiable currency unit storage facilities 111, tracking mechanisms, and verification protocols to ensure the integrity of the IPICUs 130.

In preferred embodiments, the system 100 may include the following features:
a) Scalable Architecture: The system 100 comprises a scalable architecture that can accommodate a large number of account owners 101A, 101B, and transactions. This ensures that the system 100 can handle increased demand as the user base grows.
b) High Availability: The system 100 is configured to be highly available, with redundant systems and failover mechanisms to ensure that the system 100 is accessible at all times.
c) Robust Security: The system 100 includes robust security features, including encryption, authentication, and access control mechanisms, to protect user data and transactions from unauthorized access.
d) Real-time Transaction Processing: The system 100 is configured to process transactions in real-time, ensuring that account owners 101A, 101B, can access their IPICUs 130 and execute transactions quickly and efficiently.
e) Compatibility with Public Payment Networks: The system 100 is configured to be compatible with public payment networks, e.g., open payment networks 107 and closed payment networks 108, allowing account owners 101A, 101B, to convert their IPICUs 130 to fiat currency and vice versa for incoming and outgoing payments.
f) User-friendly Interface: The system 100 is configured with a user-friendly interface, making it easy for account owners 101A, 101B, to access and navigate the system 100. This includes features such as account management tools, transaction history, and customer support.

In this manner, the system 100 provides a secure, scalable, and user-friendly platform for administering the Sustainable Monetary System. The high availability, robust security, and real-time transaction processing features ensure that the system 100 is reliable and efficient, while the compatibility with public payment networks enables users or account owners 101A, 101B, to seamlessly convert their IPICUs 130, such as gold currency units, to fiat currency for payments.

In preferred embodiments, the system 100 utilizes system integrity features which includes the following:
a) Redundancy and Backup: The system 100 is configured with redundancy and backup mechanisms to ensure system 100 integrity in case of failure or data loss. This includes backup system servers 300A, data replication, and disaster recovery plans.
b) System Monitoring: The system 100 includes monitoring tools to detect and alert for potential system issues or unauthorized access attempts. This includes system logs, intrusion detection, and continuous monitoring of system activity.
c) Authentication and Authorization: The system 100 includes strong authentication and authorization mechanisms to ensure that only authorized users (account owners 101A, 101B,) can access the system 100 and perform transactions. This includes multi-factor authentication and role-based access control.
d) Regular System Audits: The system 100 undergoes regular audits to ensure compliance with security standards and best practices. This includes vulnerability scanning, penetration testing, and regular security assessments.
e) Compliance with Regulatory Requirements: The system 100 adheres to regulatory requirements, such as AML and KYC laws, and other relevant financial regulations to ensure compliance with legal requirements and prevent fraudulent activity.
f) Geopolitical Protection: integrity of the system 100 related to geopolitical protection ensures that the Sustainable Monetary System 100 is protected from geopolitical risks, such as political instability or economic sanctions. This includes ensuring the physical security of the IPICUs 130, as well as the security of the platform and transfer features. Additionally, the system 100 is configured to comply with relevant regulations to ensure that it is not vulnerable to geopolitical risks, such as being used for money laundering or financing of terrorism. By ensuring the system's 100 integrity in the face of geopolitical risks, the Sustainable Monetary System 100 can provide a stable and secure means of conducting transactions, even in challenging geopolitical environments.

Overall, the system integrity features ensure that the system 100 is secure, reliable, and compliant with regulatory requirements. The redundancy and backup mechanisms, system monitoring, authentication and authorization, regular audits, and compliance with regulatory requirements, all work together to ensure the integrity of the system 100 and protect user data and transactions.

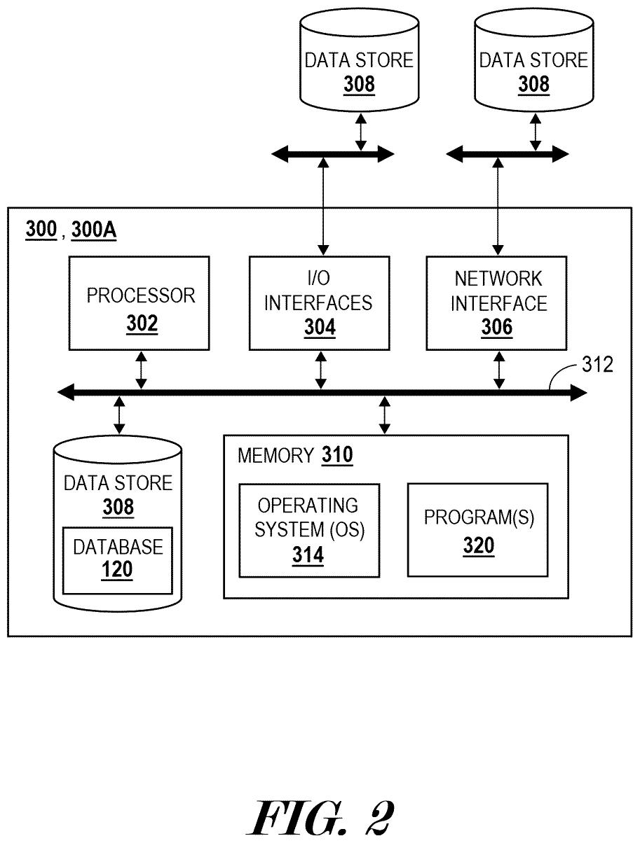

Referring now to FIG. 2, in an exemplary embodiment, a block diagram illustrates a server 300, 300A, of which one or more may be used in the system 100 or standalone and which may be a type of computing platform. A system server 300A is a server 300 that is configured to execute program instructions in order to perform one or more functions of the system 100. A server 300, 300A, may be a digital computer that, in terms of hardware architecture, generally includes a processor 302, input/output (I/O) interfaces 304, a network interface 306, a data store 308, and memory 310. It should be appreciated by those of ordinary skill in the art that FIG. 2 depicts the server 300, 300A, in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing program instructions. When the server 300, 300A, is in operation, the processor 302 is configured to execute software or programs 320 stored within the memory 310, to communicate data to and from the memory 310, and to generally control operations of the server 300 pursuant to the software or program instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, the data network 105, the enterprise, and the like, etc. The network interface 306 may include, for example, an Ethernet card or adapter (e.g., 10 BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data.

The data store 308 is a type of memory and may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300, 300A, such as, for example, an internal hard drive connected to the local interface 312 in the server 300, 300A. Additionally, in another embodiment, the data store 308 may be located external to the server 300, 300A, such as, for example, an external hard drive connected to the I/O interfaces 304 (e.g., SCSI or USB connection). In a further embodiment, the data store 308 may be connected to the server 300, 300A, through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example Windows NT, Windows 2000, Windows XP, Windows Vista, Windows 7, Windows 8, Windows 10, Windows Server 2003/2008/2012/2016 (all available from Microsoft, Corp. of Redmond, WA), Solaris (available from Sun Microsystems, Inc. of Palo Alto, CA), LINUX (or another UNIX variant) (available from Red Hat of Raleigh, NC and various other vendors), Android and variants thereof (available from Google, Inc. of Mountain View, CA), Apple OS X and variants thereof (available from Apple, Inc. of Cupertino, CA), or the like.

The one or more programs 320 may comprise program instructions stored in one or more computer-readable memories and one or more processors 302 may be configured to execute the program instructions to cause the system 100 to perform operations described herein.

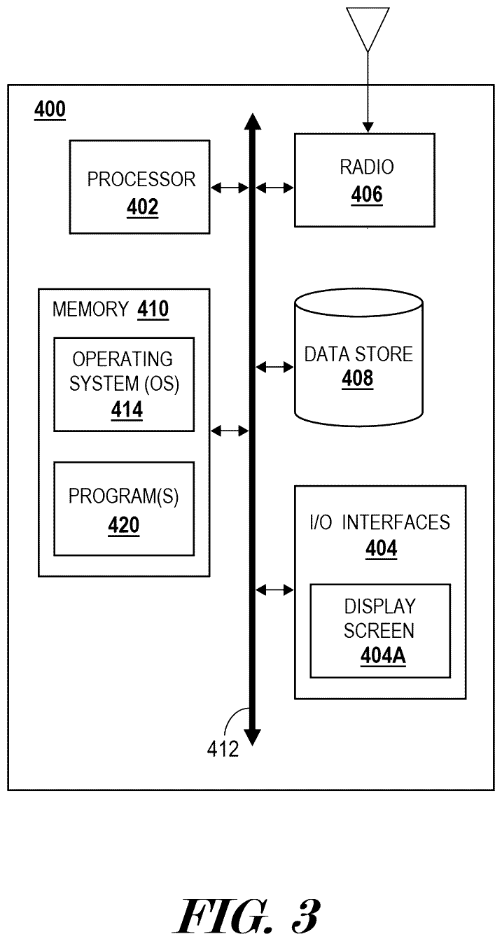

Referring to FIG. 3, in an exemplary embodiment, a block diagram illustrates a client device 400 of which one or more may be used in the system 100 or the like and which may be a type of computing platform. The client device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 3 depicts the client device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the client device 400, a semiconductor-based microprocessor (in the form of a microchip or chip set), or generally any device for executing program instructions. When the client device 400 is in operation, the processor 402 is configured to execute software or programs 420, having program instructions, stored within the memory 410, to communicate data to and from the memory 410, and to generally control operations of the client device 400 pursuant to the software or program instructions. In an exemplary embodiment, the processor 402 may include a mobile optimized processor such as optimized for power consumption and mobile applications.

The I/O interfaces 404 can be used to receive data and user input and/or for providing system output. User input can be provided via a plurality of I/O interfaces 404, such as a keypad, a touch screen, a camera, a microphone, a scroll ball, a scroll bar, buttons, barcode scanner, voice recognition, eye gesture, and the like. System output can be provided via a display screen 404A, such as a liquid crystal display (LCD), light emitting diode (LED) display, touch screen display, and the like. The I/O interfaces 404 can also include, for example, a global positioning service (GPS) radio, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the client device 400. Additionally, the I/O interfaces 404 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The data store 408 may be used to store data and is therefore a type of memory. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs 420, each of which includes an ordered listing of executable instructions for implementing logical functions. In the example of FIG. 3, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Symbian OS, Microsoft Windows CE, Microsoft Windows 7 Mobile, Microsoft Windows 10, iOS (available from Apple, Inc.), webOS (available from Hewlett Packard), Blackberry OS (Available from Research in Motion), and the like.

The one or more programs 420 may comprise program instructions stored in one or more computer-readable memories and one or more processors 402 may be configured to execute the program instructions to cause the system 100 to perform operations described herein. The programs 420 may be configured to provide end user functionality with the client device 400. For example, exemplary programs 420 may include, but not limited to, a web browser, social networking applications, streaming media applications, games, mapping and location applications, electronic mail applications, financial applications, and the like. In a typical example, the end user typically uses one or more of the programs 420 along with a network 105 to exchange information with the system 100.

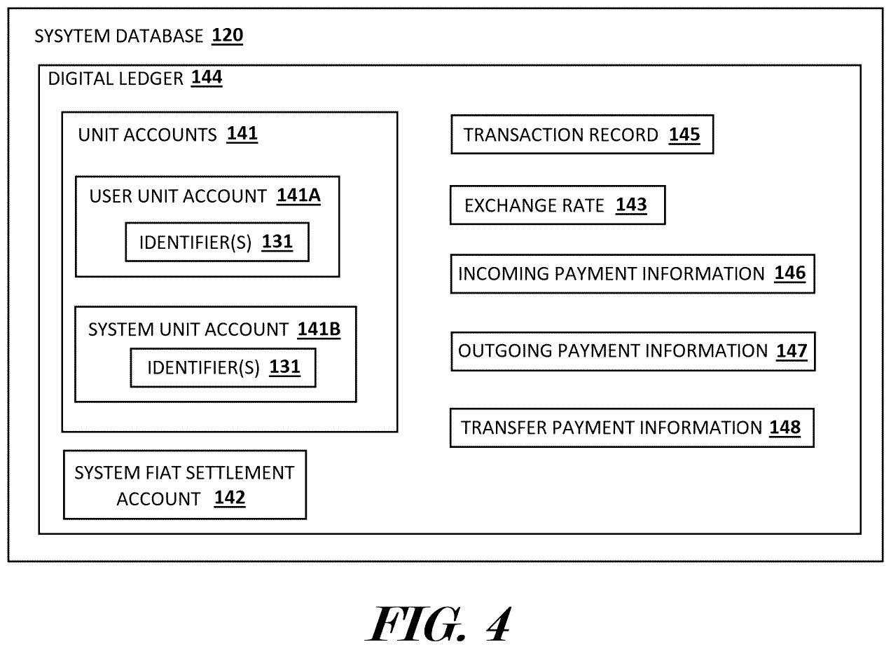

Referring now to FIG. 4, a block diagram showing an exemplary database structure of a system database 120 which may be used in the system 100 according to various embodiments described herein is illustrated. The system 100 may comprise one or more databases, such as a system database 120, which may be stored on a data store 308 accessible to system servers 300A. The data may comprise any information input into the system 100, including: information on or describing one or more account owners 101A, 101B, open payment networks 107, closed payment networks 108, third party financial institutions 109, and indivisible physical identifiable currency unit storage facilities 111, information on or describing indivisible physical identifiable currency units 130 and their respective identifiers 131, information on or describing fiat currency paid into and out of the system 100, information on or describing transactions involving indivisible physical identifiable currency units 130, and information on or describing transactions involving fiat currency, and any other data and information described herein.

A system database 120 may comprise a plurality of unit accounts 141 that may include a plurality of user unit accounts 141A and one or more system unit accounts 141B. Unit accounts 141 may contain information describing the IPICU 130 holdings of account owners 101A, 101B. User account owners 101A may include individuals and entities that have enrolled in the system 100 and may have one or more user unit accounts 141A that they may use during the performance of transactions. System account owners 101B may include individuals and entities that may own and/or administer the system 100 and may have one or more system unit account 141B that they or the system 100 may use during the performance of transactions. The identifier(s) 131 of one or more IPICUs 130 owned by the account owners 101A, 101B, may be stored or otherwise associated with a respective unit account 141A, 141B. Each identifier 131 is only able to be associated with a single unit account 141 at any given point in time.

A system database 120 may comprise one or more system fiat settlement accounts 142 which may be used by the system 100 for receiving fiat currency payments into the system 100 and for sending fiat currency payments out of the system 100.

A system database 120 may comprise one or more exchange rates 143 which may be determined by and used by the system 100 for performing transactions, such as exchanging an amount of fiat currency for a number of IPICUs 130 and vice versa, exchanging an amount or number of one type of IPICU 130 for an amount or number of another type of IPICU 130, etc. In preferred embodiments, the system 100 is configured to perform a conversion function that enables the conversion of IPICUs 130 of different weights and/or types to another type of IPICU 130. For example, this function facilitates the conversion of 1 Kg bars to 31 Oz bullion coins, and vice versa. To ensure the accuracy of the conversion process, the system 100 includes a precise measurement system that adheres to established protocols for gold and other metals weight and purity, and also utilizes standard weights and measures. Additionally, the conversion process is executed in real-time, with a stock-out of the source currency type of IPICUs 130 and a stock-in of the target currency type of IPICUs 130. This means that the conversion happens instantly, ensuring timely and accurate transaction processing. Overall, the system's 100 conversion function provides a flexible and accurate platform for the conversion of IPICUs 130 between different weights, with real-time processing for a seamless user experience.

In some embodiments, a system database 120 may comprise a digital ledger 144. A digital ledger 144 may be used by the system 100 to record transaction information of account owners 101A, 101B, the physical location of IPICUs 130, and ownership of IPICUs 130 for their respective account owners 101A, 101B, as private tangible property. The system 100 updates the digital ledger 144 with transactions in real-time from one account owner 101A, 101B, to another.

In some embodiments, a system database 120 may include a plurality of data records that may include: transaction records 145, incoming payment information 146 records, outgoing payment information 147 records, and transfer payment information 148 records, that optionally may be stored in a digital ledger 144.

A transaction record 145 may comprise data describing a transaction performed or processed on the system 100, such as information describing the transfer of IPICUs 130 between account owners 101A, 101B, information describing the purchasing or acquiring of IPICUs 130 by an account owner 101A, 101B, information describing the selling of IPICUs 130 by an account owner 101A, 101B, information describing the exchange of one type of IPICU 130 for another by an account owner 101A, 101B, information describing the exchange of IPICU(s) 130 for an amount of fiat currency by an account owner 101A, 101B, information describing payments outgoing from the system 100 of fiat currency by an account owner 101A, 101B, information describing payments incoming to the system 100 of fiat currency by an account owner 101A, 101B, etc. Transaction records 145 may also include the unit accounts 141 of one or more account owners 101A, 101B, participating in a transaction along with time and date stamps and any other information describing a transaction.

Incoming payment information 146, optionally stored in or otherwise associated with a transaction record 145, may describe an amount of fiat currency incoming to the system 100, the source of the fiat currency, e.g., the open payment network 107 source, closed payment network 108 source, third party financial institution 109 source, etc., account information of the account sending the fiat currency, unit account 141 and preferably account owner 101A, 101B, to be credited with the incoming payment. Outgoing payment information 147, optionally stored in or otherwise associated with a transaction record 145, may describe an amount of fiat currency outgoing from the system 100, the source of the fiat currency, e.g., the unit account 141 and preferably the account owner 101A, 101B, debited with the outgoing payment, the account information of the destination account receiving the fiat currency, e.g., open payment network 107 destination, closed payment network 108 destination, third party financial institution 109 destination, etc., to be credited with the outgoing payment. Transfer payment information 148, optionally stored in or otherwise associated with a transaction record 145, may describe an amount of fiat currency and/or IPICUs 130 transferred between two or more unit accounts 141 of account owners 101A, 101B, of the system 100.

Generally, the system 100 of the present invention is configured to execute program instructions, via one or more processors 302, 402, to cause the system 100 to perform operations for administering one or more unit accounts 141 that hold IPICUs 130 for a plurality of user account owners 101A, 101B.

In preferred embodiments, a user unit account 141A may be created for each user account owner 101A who wants to hold one or more IPICUs 130. The account creation process involves collecting identifying information from the applicant, screening the applicant through the Anti-money Laundering system, and setting up a user unit account 141A with the system 100.

Once a user unit account 141A is created, the user account owner 101A may acquire one or more IPICUs 130 that will be held in the user unit account 141A. The system 100 may provide various ways for the user account owner 101A to acquire IPICUs 130, such as purchasing them directly from a system unit account 141B of the system 100 or acquiring them from another user account owner 101A.

Each IPICU 130 of the system 100, and therefore acquired by an account owner 101A, 101B, is identified with a unique identifier 131 that is recorded in the system database 120. This identifier 131 is used to track ownership of each IPICU 130 and to ensure that each IPICU 130 can be easily identified and tracked physically and digitally.

The system 100 manages each unit account 141, keeping track of any IPICUs 130 held in the account 141 and the account owner's 101A, 101B, identifying information in a system database. The system 100 may also provide tools for the account owner 101A, 101B, to manage their account 141, such as the ability to transfer IPICUs 130 to other accounts 141 or to redeem or exchange the IPICUs 130 for cash/desired fiat currency.

The system 100 keeps track of all transactions involving IPICUs 130 and fiat currency, including the acquisition and transfer of IPICUs 130 between accounts 141 in transaction records 145. This record-keeping is essential for ensuring the accuracy of account 141 balances and for detecting any fraudulent activity.

The system 100 also ensured the security of the IPICUs 130 digitally held in the accounts 141 and physically held in the indivisible physical identifiable currency unit storage facilities 111. This may involve physical security measures, such as secure storage facilities, as well as digital security measures, such as encryption and secure communication protocols.

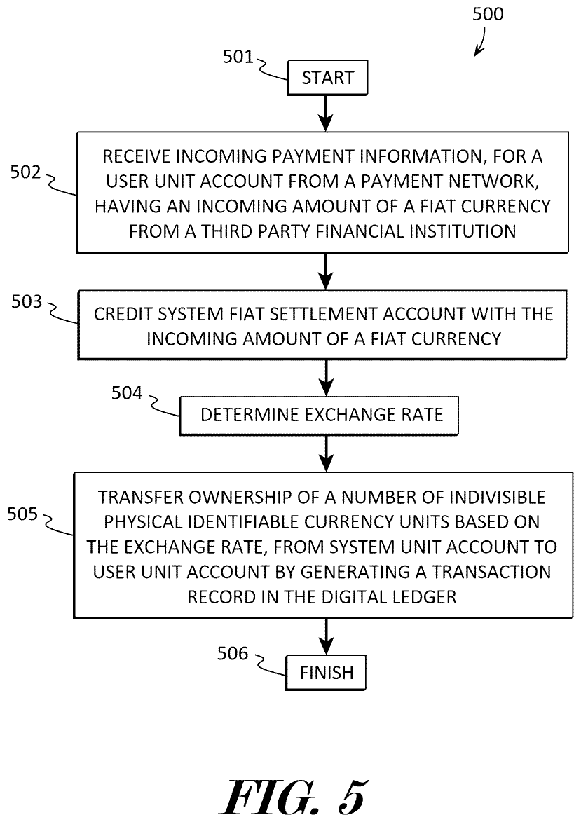

FIG. 5 shows a block diagram of an example of a computer-implemented method for real-time processing of incoming payments in fiat currency from an open payment network 107, a closed payment network 108, a third party financial institution 109, or other payment source, and converting the incoming payments to IPICUs 130 that may be added to a unit account 141 (“the method”) 500 according to various embodiments described herein. Program instructions, such as contained in one or more programs 320, 420, and stored in one or more computer-readable memories 310, 410, may be executed via one or more processors 302, 402, to cause the system 100 to perform the steps of the method 500.

The method 500 may start 501 and the system 100 may receive incoming payment information 146, for a user unit account 141A from a payment network 107, 108, having an incoming amount of a fiat currency from a third party financial institution 109 via a network connection 104 in step 502. Preferably, the system 100 may receive incoming payment information 146 associated with an incoming payment in fiat currency from an open payment network 107 that contains the details of the incoming payment e.g., the incoming amount of a fiat currency and the user unit account 141A that the incoming payment is to be applied. Preferably, the incoming payment may be generated and/or received via a client device 400, server 300, 300A.

In step 503, the system 100 may credit a system fiat settlement account 142 with the incoming amount of a fiat currency.

In step 504, the system 100 may determine an exchange rate 143. Preferably, an exchange rate 143 may be determined between the fiat currency and IPICUs 130 based on a current market value of the desired type of IPICUs 130, optionally selected by the user account owner 101A of the user unit account 141A. The exchange rate 143 may describe a number of IPICUs 130 having equivalent value or approximately equivalent value, such as by rounding to the nearest whole number, to the amount of a fiat currency of the incoming payment based on the exchange rate 143 between the fiat currency and IPICUs 130.

In step 505, the system 100 may transfer ownership of a number of IPICUs 130 based on the exchange rate 143 from a system unit account 141B to the user unit account 141A by generating a transaction record 145 in the digital ledger 144. In preferred embodiments, the system 100 may transfer ownership of the number of IPICUs 130, the number equal to the exchange rate 143, from a system unit account 141B to the user unit account 141A by generating a transaction record 145 in the digital ledger 144, in which the transaction record 145 simultaneously disassociates the identifiers 131 of the number of IPICUs 130 from the system unit account 141B and associates the identifiers of number of IPICUs 130 with the user unit account 141A. Generally, the system 100 identifies one or more specific IPICUs 130 associated with the converted payment value and transfers ownership of the number of IPICUs 130 from a system unit account 141B to the user unit account 141A by generating a transaction record 145 in the digital ledger 144. The system 100 may update the account balances of both the payer and the payee in real-time to reflect the processed transaction. The transaction record 145 stored in a system database 120 provides a record of the transaction for auditing and verification purposes ensuring that the transaction can be audited and verified if needed. After step 505, the method 500 may finish 506.

In this manner, the method 500 provides real-time payment processing that converts incoming payments in fiat currency into IPICUs 130. The system 100 and method 500 ensures that the payee user account owner 101A owns specific IPICUs 130 corresponding to the payment made, as the identified IPICUs 130. The system also updates the account balances of both the payer and the payee in real-time, providing an up-to-date record of their account balances. This method 500 provides a secure and transparent way to process payments in fiat currency and convert them to IPICUs 130, making it an innovative solution for the payment processing industry.

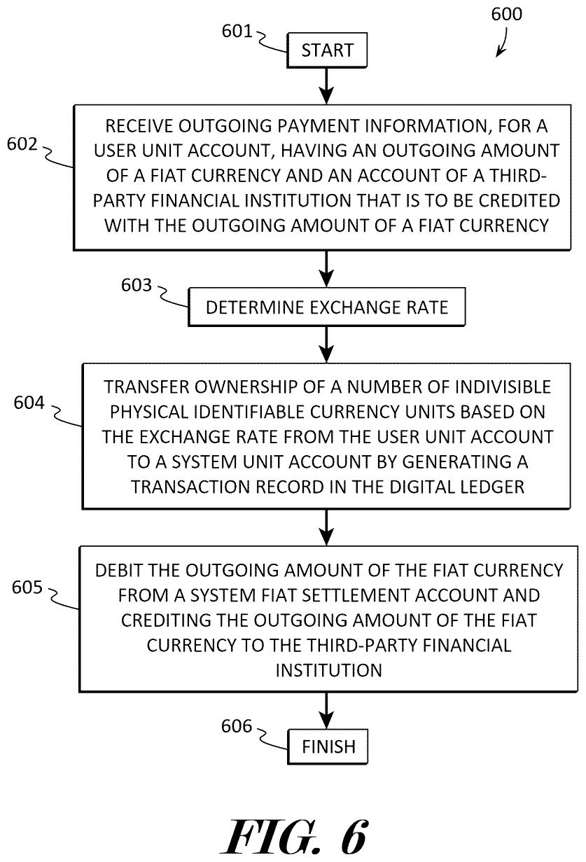

FIG. 6 shows a block diagram of an example of a computer-implemented method for real-time processing of authorized outgoing payments in fiat currency over an open payment network 107, a closed payment network 108, a third party financial institution 109, or other payment destination, and settling the payment amount from a user account holder's or owner's 101A user unit account 141A (“the method”) 600 according to various embodiments described herein. Program instructions, such as contained in one or more programs 320, 420, and stored in one or more computer-readable memories 310, 410, may be executed via one or more processors 302, 402, to cause the system 100 to perform the steps of the method 600.

The method 600 may start 601 and the system 100 may receive outgoing payment information 147, for a user unit account 141A of a user account owner 101A, having an outgoing amount of a fiat currency and an account of a third-party financial institution 109 that is to be credited with the outgoing amount of a fiat currency in step 602. Preferably, the outgoing payment information 147 may be generated and/or received via a client device 400 of the user account owner 101A.

In step 603, the system 100 may determine an exchange rate 143. Preferably, an exchange rate 143 may be determined between the fiat currency and IPICUs 130 based on a current market value of the desired type of IPICUs 130, optionally selected by the user account owner 101A of the user unit account 141A. The exchange rate 143 may describe a number of IPICUs 130 having equivalent value or approximately equivalent value, such as by rounding to the nearest whole number, to the amount of a fiat currency of the incoming payment based on the exchange rate 143 between the fiat currency and IPICUs 130. In preferred embodiments, the system 100 may verify that the user unit account 141A has a sufficient number of IPICUs 130 to cover the payment.

In step 604, the system 100 may transfer ownership of a number of IPICUs 130 based on the exchange rate 143 from the user unit account 141A to a system unit account 141B by generating a transaction record 145 in the digital ledger 144. In preferred embodiments, the system 100 may transfer ownership of the number of IPICUs 130, the number equal to the exchange rate 143, from the user unit account 141A to a system unit account 141B by generating a transaction record 145 in the digital ledger 144, in which the transaction record 145 simultaneously disassociates the identifiers 131 of the number of IPICUs 130 from the user unit account 141A and associates the identifiers of number of IPICUs 130 with the system unit account 141B. Generally, the system 100 identifies one or more specific IPICUs 130 associated with the converted payment value and transfers ownership of the number of IPICUs 130 from the user unit account 141A to a system unit account 141B by generating a transaction record 145 in the digital ledger 144. The system 100 may update the account balances of both the payer and the payee in real-time to reflect the processed transaction. The transaction record 145 stored in a system database 120 provides a record of the transaction for auditing and verification purposes ensuring that the transaction can be audited and verified if needed.

In step 605, the system 100 may debit the outgoing amount of the fiat currency from a system fiat settlement account 142 and credit the outgoing amount of the fiat currency to the third-party financial institution 109 and/or to the payee account at the third-party financial institution 109. In this manner, method 600 provides real-time payment processing that converts outgoing payments in IPICUs 130 into fiat currency. After step 605, method 600 may finish 606.

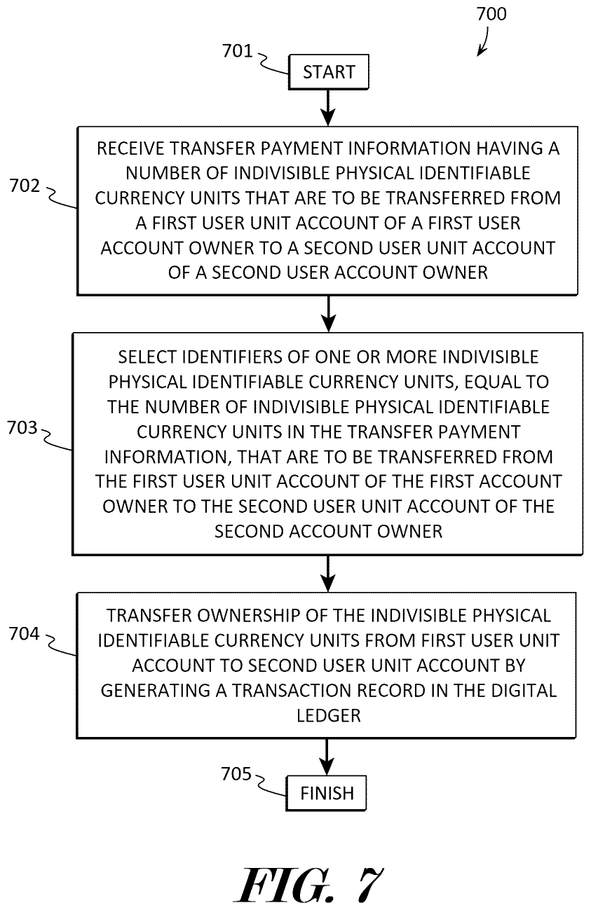

FIG. 7 depicts a block diagram of an example of a computer-implemented method for real-time processing of authorized transfers of IPICUs 130 between the unit accounts 141 of two or more account owners 101A, 101B, (“the method”) 700 according to various embodiments described herein. Program instructions, such as contained in one or more programs 320, 420, and stored in one or more computer-readable memories 310, 410, may be executed via one or more processors 302, 402, to cause the system 100 to perform the steps of the method 700.

The method 700 may start 701 and the system 100 may receive transfer payment information 148, the transfer payment information 148 having a number of IPICUs 130 that are to be transferred from a first user unit account 141A of a first user account owner 101A to a second user unit account 141A of a second user account owner 101A in step 702. Preferably, the transfer payment information 148 may be received from a client device 400 of the first user account owner 101A. Optionally, the number of IPICUs 130 that are to be transferred may be selected by the first user 101A or the first user 101A may enter a monetary value to be transferred and the system 100 may determine an exchange rate 143 and use the exchange rate 143 to determine the number of IPICUs 130 that are to be transferred. Preferably, the system 100 may verify that the first user account owner 101A has sufficient IPICUs 130 in their first user unit account 141A to cover the transfer value.

In step 703, preferably the system 100, or optionally the first user account owner 101A, may select identifiers 131 of IPICUs 130, equal to the number of IPICUs 130 in the transfer payment information 148, that are to be transferred from the first user unit account 141A of the first account owner 101A to the second user unit account 141A of the second account owner 101A. Generally, the system 100, or optionally the first user account owner 101A, may select which IPICUs 130 that the first user 101A owns are to be transferred to the second user account owner 101A.

In step 704, the system 100 may transfer ownership of the IPICUs 130 from the first user unit account 141A to the second user unit account 141B by generating a transaction record 145 in the digital ledger 144. In preferred embodiments, the system 100 may transfer ownership of the IPICUs 130 from the first user unit account 141A to the second user unit account 141B by generating a transaction record 145 in the digital ledger 144 in which the transaction record 145 simultaneously disassociates the one or more identifiers 131 of the selected IPICUs 130 from the first user unit account 141A and associates the one or more identifiers 131 with the second user unit account 141A. In this manner, the system 100 may update account balances of both the first and second user account owners 101A in real-time to reflect the processed transfer transaction, and the transaction record 145 stores a record of the transfer transaction in the system database 120 providing a transfer history for both the first and second user account owners 101A to view and verify past transfer transactions. Preferably, the system 100 may provide notifications to both the first and second user account owners 101A, via their respective client devices 400, of the transfer transaction completion. The system 100 may also provide a sale history for both user account owners 101A to view and verify past sale transactions using the transaction records 145 maintained by the system 100. The system 100 may also enforce any transfer restrictions, such as minimum or maximum transfer amounts, as defined by the system 100 or user account owners 101A. After step 704, method 700 may finish 705.

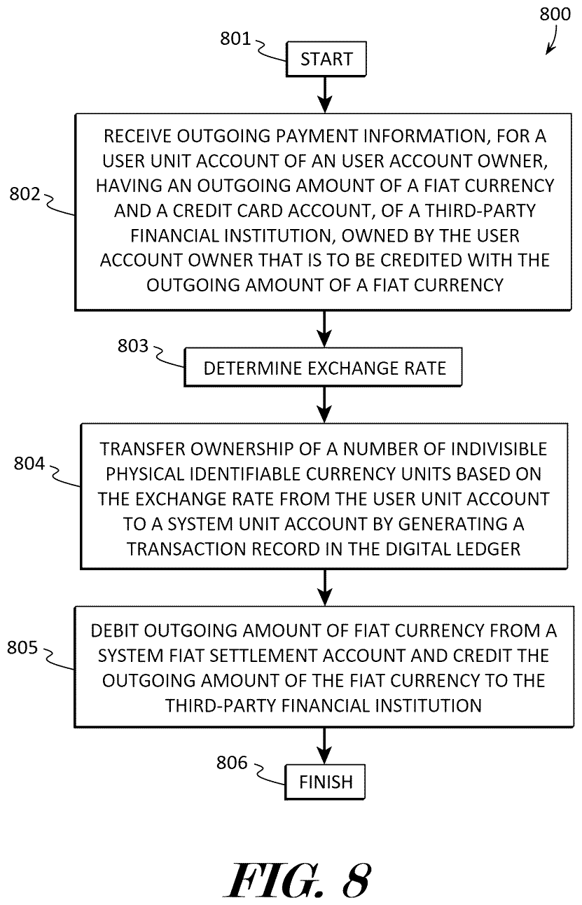

FIG. 8 illustrates a block diagram of an example of a computer-implemented method for real-time processing of authorized payment of a user account owner's 101A sale of one or more IPICUs 130, and paying them out to a credit card account, of a third party financial institution 109, owned by the user account owner 101A e.g., paying them out on the user account owner's 101A credit card (“the method”) 800 according to various embodiments described herein. Program instructions, such as contained in one or more programs 320, 420, and stored in one or more computer-readable memories 310, 410, may be executed via one or more processors 302, 402, to cause the system 100 to perform the steps of the method 800.

The method 800 may start 801 and the system 100 may receive outgoing payment information 147, for a user unit account 141A of a user account owner 101A, having an outgoing amount of a fiat currency and a credit card account, of a third-party financial institution 109, owned by the user account owner 101A that is to be credited with the outgoing amount of a fiat currency in step 802. Preferably, the outgoing payment information 147 may be generated and/or received via a client device 400 of the user account owner 101A.

In step 803, the system 100 may determine an exchange rate 143. Preferably, an exchange rate 143 may be determined between the fiat currency and IPICUs 130 based on a current market value of the desired type of IPICUs 130, optionally selected by the user account owner 101A of the user unit account 141A. The exchange rate 143 may describe a number of IPICUs 130 having equivalent value or approximately equivalent value, such as by rounding to the nearest whole number, to the amount of a fiat currency of the incoming payment based on the exchange rate 143 between the fiat currency and IPICUs 130. In preferred embodiments, the system 100 may verify that the user unit account 141A has a sufficient number of IPICUs 130 to cover the payment.

In step 804, the system 100 may transfer ownership of a number of IPICUs 130 based on the exchange rate 143 from the user unit account 141A to a system unit account 141B by generating a transaction record 145 in the digital ledger 144. In preferred embodiments, the system 100 may transfer ownership of the number of IPICUs 130, the number equal to the exchange rate 143, from the user unit account 141A to a system unit account 141B by generating a transaction record 145 in the digital ledger 144, in which the transaction record 145 simultaneously disassociates the identifiers 131 of the number of IPICUs 130 from the user unit account 141A and associates the identifiers of number of IPICUs 130 with the system unit account 141B. Generally, the system 100 identifies one or more specific IPICUs 130 associated with the converted payment value and transfers ownership of the number of IPICUs 130 from the user unit account 141A to a system unit account 141B by generating a transaction record 145 in the digital ledger 144. The system 100 may update the account balances of both the payer and the payee in real-time to reflect the processed transaction. The transaction record 145 stored in a system database 120 provides a record of the transaction for auditing and verification purposes ensuring that the transaction can be audited and verified if needed.

In step 805, the system 100 may debit the outgoing amount of the fiat currency from a system fiat settlement account 142 and credit the outgoing amount of the fiat currency to the third-party financial institution 109 and/or to the account owner's 101A credit card account at the third-party financial institution 109. In this manner, the method 800 provides real-time payment processing that converts outgoing payments in IPICUs 130 into fiat currency and onto the account owner's 101A credit card. Preferably, the system 100 may provide a notification to the user account owner 101A, via their respective client device 400, of the transfer transaction completion. The system 100 may also provide a sale history for the user account owner 101A to view and verify past sale transactions using the transaction records 145 maintained by the system 100. The system 100 may also enforce any transfer restrictions, such as minimum or maximum transfer amounts, as defined by the system 100 or user account owner 101A. After step 805, the method 800 may finish 806.

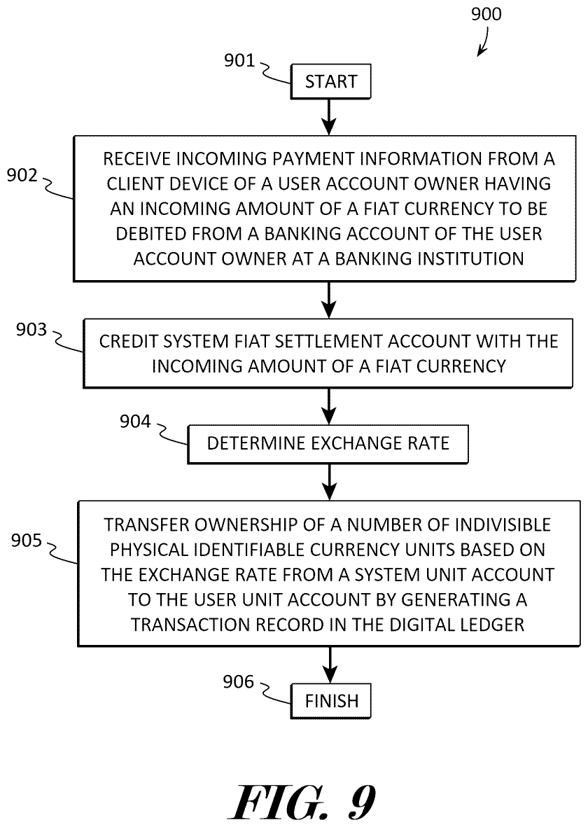

FIG. 9 shows a block diagram of an example of a computer-implemented method for real-time settlement of a user account owner's 101A purchase of IPICUs 130 with fiat currency from a bank account, of a third party financial institution 109, owned by the user account owner 101A (“the method”) 900 according to various embodiments described herein. Program instructions, such as contained in one or more programs 320, 420, and stored in one or more computer-readable memories 310, 410, may be executed via one or more processors 302, 402, to cause the system 100 to perform the steps of the method 900.

The method 900 may start 901 and the system 100 may receive incoming payment information 146 for a user unit account 141A of a user account owner 101A from a from a client device 400 of the user account owner 101A, the incoming payment information 146 comprising an incoming amount of a fiat currency to be debited from a banking account of the user account owner 101A at the banking institution type of third party financial institution 109 in step 902. Preferably, the incoming payment information 146 may be received by a system server 300A. In preferred embodiments, the system 100 may verify that the banking account of the user account owner 101A at the banking institution type of third party financial institution 109 has a sufficient amount of fiat currency to cover the amount of a fiat currency to be debited.

In step 903, the system 100 may credit a system fiat settlement account 142 with the incoming amount of a fiat currency.

In step 904, the system 100 may determine an exchange rate 143. Preferably, an exchange rate 143 may be determined between the fiat currency and IPICUs 130 based on a current market value of the desired type of IPICUs 130, optionally selected by the user account owner 101A of the user unit account 141A. The exchange rate 143 may describe a number of IPICUs 130 having equivalent value or approximately equivalent value, such as by rounding to the nearest whole number, to the amount of a fiat currency of the incoming payment based on the exchange rate 143 between the fiat currency and IPICUs 130.

In step 905, the system 100 may transfer ownership of a number of IPICUs 130 based on the exchange rate 143 from a system unit account 141B to the user unit account 141A by generating a transaction record 145 in the digital ledger 144. In preferred embodiments, the system 100 may transfer ownership of the number of IPICUs 130, the number equal to the exchange rate 143, from the system unit account 141B to the user unit account 141A by generating a transaction record 145 in the digital ledger 144, in which the transaction record 145 simultaneously disassociates the identifiers 131 of the number of IPICUs 130 from the system unit account 141B and associates the identifiers of number of IPICUs 130 with the user unit account 141A. Generally, the system 100 identifies one or more specific IPICUs 130 associated with the converted payment value and transfers ownership of the number of IPICUs 130 from the system unit account 141B to the user unit account 141A by generating a transaction record 145 in the digital ledger 144. The system 100 may update the account balances of both the payer and the payee in real-time to reflect the processed transaction. The transaction record 145 stored in a system database 120 provides a record of the transaction for auditing and verification purposes ensuring that the transaction can be audited and verified if needed. In this manner, the method 900 provides real-time payment processing that converts incoming fiat currency payments from a banking account owned by a user account owner 101A into a number of IPICUs 130 that are deposited into a user unit account 141A of the user account owner 101A. Preferably, the system 100 may provide a notification to the user account owner 101A, via their respective client device 400, of the transfer transaction completion. The system 100 may also provide a sale history for the user account owner 101A to view and verify past sale transactions using the transaction records 145 maintained by the system 100. The system 100 may also enforce any transfer restrictions, such as minimum or maximum transfer amounts, as defined by the system 100 or user account owner 101A. After step 905, the method 900 may finish 906.

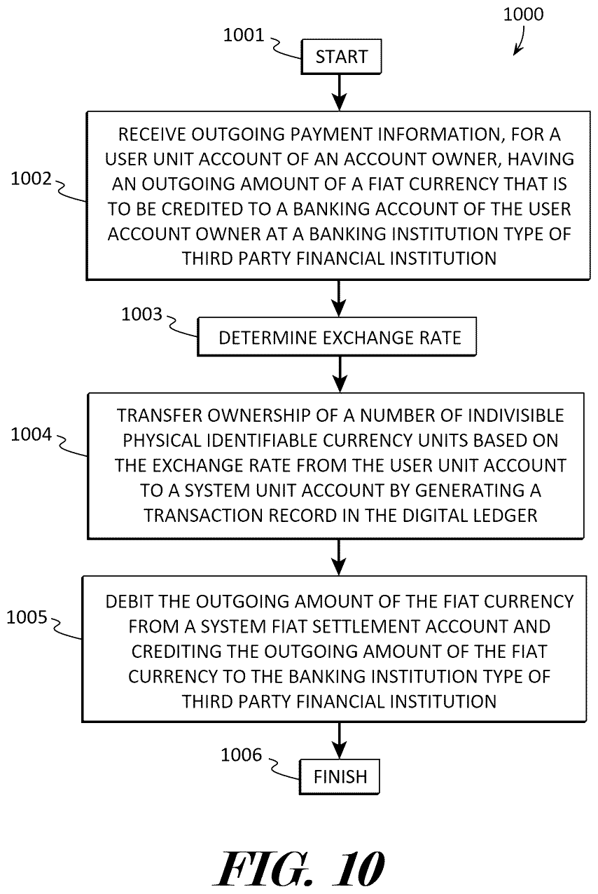

FIG. 10 shows a block diagram of an example of a computer-implemented method for real-time settlement of user account owner's 101A sale of IPICUs 130 with a banking account, of a third party financial institution 109, owned by the user account owner 101A (“the method”) 1000 according to various embodiments described herein. Program instructions, such as contained in one or more programs 320, 420, and stored in one or more computer-readable memories 310, 410, may be executed via one or more processors 302, 402, to cause the system 100 to perform the steps of the method 1000.

The method 1000 may start 1001 and the system 100 may receive outgoing payment information 147 for a user unit account 141A of a user account owner 101A from a from a client device 400 of the user account owner 101A, the outgoing payment information 147 comprising an incoming amount of a fiat currency to be credited to a banking account of the user account owner 101A at a banking institution type of third party financial institution 109 in step 1002. Preferably, the outgoing payment information 147 may be received by a system server 300A. In preferred embodiments, the system 100 may verify that the user unit account 141A of the user account owner 101A has a sufficient amount of IPICUs 130 to cover the amount of a fiat currency to be credited.

In step 1003, the system 100 may determine an exchange rate 143. Preferably, an exchange rate 143 may be determined between the fiat currency and IPICUs 130 based on a current market value of the desired type of IPICUs 130, optionally selected by the user account owner 101A of the user unit account 141A. The exchange rate 143 may describe a number of IPICUs 130 having equivalent value or approximately equivalent value, such as by rounding to the nearest whole number, to the amount of a fiat currency of the outgoing payment based on the exchange rate 143 between the fiat currency and IPICUs 130.

In step 1004, the system 100 may transfer ownership of a number of IPICUs 130 based on the exchange rate 143 from the user unit account 141A to a system unit account 141B by generating a transaction record 145 in the digital ledger 144. In preferred embodiments, the system 100 may transfer ownership of the number of IPICUs 130, the number equal to the exchange rate 143, from the user unit account 141A to the system unit account 141B by generating a transaction record 145 in the digital ledger 144, in which the transaction record 145 simultaneously disassociates the identifiers 131 of the number of IPICUs 130 from the user unit account 141A and associates the identifiers of number of IPICUs 130 with the system unit account 141B. Generally, the system 100 identifies one or more specific IPICUs 130 associated with the converted payment value and transfers ownership of the number of IPICUs 130 from the user unit account 141A to the system unit account 141B by generating a transaction record 145 in the digital ledger 144.

In step 1005, the system 100 may debit the outgoing amount of the fiat currency from a system fiat settlement account 142 and credit the outgoing amount of the fiat currency to the banking institution type third party financial institution 109 so that it may be credited to or deposited into the banking account of the user account owner 101A at a banking institution type of third party financial institution 109.

The system 100 may update the account balances of both the payer and the payee in real-time to reflect the processed transaction. The transaction record 145 stored in a system database 120 provides a record of the transaction for auditing and verification purposes ensuring that the transaction can be audited and verified if needed. In this manner, the method 900 provides real-time payment processing that converts a number of IPICUs 130 that are debited from a user unit account 141A of the user account owner 101A into outgoing fiat currency payments to a banking account owned by the user account owner 101A. Preferably, the system 100 may provide a notification to the user account owner 101A, via their respective client device 400, of the transfer transaction completion. The system 100 may also provide a sale history for the user account owner 101A to view and verify past sale transactions using the transaction records 145 maintained by the system 100. The system 100 may also enforce any transfer restrictions, such as minimum or maximum transfer amounts, as defined by the system 100 or user account owner 101A. After step 1005, the method 1000 may finish 1006.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine-readable storage device, a machine-readable storage substrate, a memory device, a composition of matter effecting a machine readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors (computing device processors) executing one or more computer applications or programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), light emitting diode (LED) display, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random-access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD), light emitting diode (LED) display, or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to a processor for execution. For example, the instructions may initially be carried on a magnetic disk of a remote computer. The remote computer can load the instructions for implementing all or a portion of the present invention remotely into a dynamic memory and send the instructions over the air (e.g., through a wireless cellular network or WiFi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on a storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetric digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device or client device such as a personal digital assistant (PDA), laptop computer, tablet computer, smartphone, or cellular telephone. The LAN communications network and the other communications networks such as cellular wireless and Wi-Fi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A Sustainable Monetary System, the system comprising:
a plurality of Indivisible Physical Identifiable Currency Units, wherein each Indivisible Physical Identifiable Currency Unit of the plurality of Indivisible Physical Identifiable Currency Units comprises an identifier, and wherein each identifier is unique to each Indivisible Physical Identifiable Currency Unit;
a digital ledger stored in one or more computer-readable data stores, wherein the digital ledger comprises a plurality of unit accounts;
program instructions stored in one or more computer-readable memories; and
one or more processors configured to execute the program instructions to cause the system to perform operations comprising:
administering the plurality of unit accounts, each of which belongs to one or more account owners, wherein each identifier is associated with a single unit account at any given point in time.

2. The system of claim 1, wherein the identifier of each Indivisible Physical Identifiable Currency Unit is physically affixed to that Indivisible Physical Identifiable Currency Unit.

3. The system of claim 2, wherein at least one Indivisible Physical Identifiable Currency Unit comprises one of a gold bullion coin and a gold bullion bar.

4. The system of claim 1, wherein the one or more processors are configured to execute the program instructions to cause the system to perform operations comprising:
receiving incoming payment information for a user unit account from a payment network, the incoming payment information comprising an incoming amount of a fiat currency from a third party financial institution;
crediting a system fiat settlement account with the incoming amount of a fiat currency;
determining an exchange rate, the exchange rate describing a number of Indivisible Physical Identifiable Currency Units having a value equal to the incoming amount of the fiat currency based on an exchange rate between the fiat currency and Indivisible Physical Identifiable Currency Units; and
transferring ownership of a number of Indivisible Physical Identifiable Currency Units, the number equal to the exchange rate, from a system unit account to the user unit account by generating a transaction record in the digital ledger, wherein the transaction record simultaneously disassociates the identifiers of the number of Indivisible Physical Identifiable Currency Units from the system unit account and associates the identifiers of number of Indivisible Physical Identifiable Currency Units with the user unit account.

5. The system of claim 4, wherein the identifier of each Indivisible Physical Identifiable Currency Unit is physically affixed to that Indivisible Physical Identifiable Currency Unit.

6. The system of claim 5, wherein at least one Indivisible Physical Identifiable Currency Unit comprises one of a gold bullion coin and a gold bullion bar.

7. The system of claim 1, wherein the one or more processors are configured to execute the program instructions to cause the system to perform operations comprising:
receiving outgoing payment information for a user unit account, the outgoing payment information comprising an outgoing amount of a fiat currency and an account of a third-party financial institution that is to be credited with the outgoing amount of a fiat currency;
determining an exchange rate, the exchange rate describing a number of Indivisible Physical Identifiable Currency Units having a value equal to the outgoing amount of the fiat currency based on an exchange rate between the fiat currency and Indivisible Physical Identifiable Currency Units;
transferring ownership of a number of Indivisible Physical Identifiable Currency Units, the number equal to the exchange rate, from the user unit account to a system unit account by generating a transaction record in the digital ledger, wherein the transaction record simultaneously disassociates the identifiers of the number of Indivisible Physical Identifiable Currency Units from the user unit account and associates the identifiers of number of Indivisible Physical Identifiable Currency Units with the system unit account; and
debiting the outgoing amount of the fiat currency from a system fiat settlement account and crediting the outgoing amount of the fiat currency to the third-party financial institution.

8. The system of claim 7, wherein the identifier of each Indivisible Physical Identifiable Currency Unit is physically affixed to that Indivisible Physical Identifiable Currency Unit.

9. The system of claim 8, wherein at least one Indivisible Physical Identifiable Currency Unit comprises one of a gold bullion coin and a gold bullion bar.

10. The system of claim 1, wherein the one or more processors are configured to execute the program instructions to cause the system to perform operations comprising:
receiving transfer payment information, the transfer payment information comprising a number of Indivisible Physical Identifiable Currency Units that are to be transferred from a first user unit account of a first user account owner to a second user unit account of a second user account owner;
selecting identifiers of one or more Indivisible Physical Identifiable Currency Units, equal to the number of Indivisible Physical Identifiable Currency Units in the transfer payment information, that are to be transferred from the first user unit account of the first user account owner to the second user unit account of the second user account owner; and
transferring ownership of the one or more Indivisible Physical Identifiable Currency Units from the first user unit account to the second user unit account by generating a transaction record in the digital ledger, wherein the transaction record simultaneously disassociates the one or more identifiers from the first user unit account and associates the one or more identifiers with the second user unit account.

11. The system of claim 10, wherein the identifier of each Indivisible Physical Identifiable Currency Unit is physically affixed to that Indivisible Physical Identifiable Currency Unit.

12. The system of claim 11, wherein at least one Indivisible Physical Identifiable Currency Unit comprises one of a gold bullion coin and a gold bullion bar.

13. The system of claim 1, wherein the one or more processors are configured to execute the program instructions to cause the system to perform operations comprising:
receiving outgoing payment information for a user unit account of an account owner, the outgoing payment information comprising an outgoing amount of a fiat currency and a credit card account, of a third-party financial institution, owned by the account owner that is to be credited with the outgoing amount of a fiat currency;
determining an exchange rate, the exchange rate describing a number of Indivisible Physical Identifiable Currency Units having a value equal to the outgoing amount of the fiat currency based on an exchange rate between the fiat currency and Indivisible Physical Identifiable Currency Units;
transferring ownership of a number of Indivisible Physical Identifiable Currency Units, the number equal to the exchange rate, from the user unit account to a system unit account by generating a transaction record in the digital ledger, wherein the transaction record simultaneously disassociates the identifiers of the number of Indivisible Physical Identifiable Currency Units from the user unit account and associates the identifiers of number of Indivisible Physical Identifiable Currency Units with the system unit account; and
debiting the outgoing amount of the fiat currency from a system fiat settlement account and crediting the outgoing amount of the fiat currency to the third-party financial institution.

14. The system of claim 13, wherein the identifier of each Indivisible Physical Identifiable Currency Unit is physically affixed to that Indivisible Physical Identifiable Currency Unit.

15. The system of claim 14, wherein at least one Indivisible Physical Identifiable Currency Unit comprises one of a gold bullion coin and a gold bullion bar.

16. The system of claim 1, wherein the one or more processors are configured to execute the program instructions to cause the system to perform operations comprising:
receiving incoming payment information for a user unit account of a user account owner from a client device of the user account owner, the incoming payment information comprising an incoming amount of a fiat currency to be debited from a banking account of the account owner at a banking institution type of third party financial institution;
crediting a system fiat settlement account with the incoming amount of a fiat currency;
determining an exchange rate, the exchange rate describing a number of Indivisible Physical Identifiable Currency Units having a value equal to the amount of a fiat currency based on an exchange rate between the fiat currency and Indivisible Physical Identifiable Currency Units; and
transferring ownership of a number of Indivisible Physical Identifiable Currency Units, the number equal to the exchange rate, from a system unit account to the user unit account by generating a transaction record in the digital ledger, wherein the transaction record simultaneously disassociates the identifiers of the number of Indivisible Physical Identifiable Currency Units from the system unit account and associates the identifiers of number of Indivisible Physical Identifiable Currency Units with the user unit account.

17. The system of claim 16, wherein the identifier of each Indivisible Physical Identifiable Currency Unit is physically affixed to that Indivisible Physical Identifiable Currency Unit.

18. The system of claim 17, wherein at least one Indivisible Physical Identifiable Currency Unit comprises one of a gold bullion coin and a gold bullion bar.

19. The system of claim 1, wherein the one or more processors are configured to execute the program instructions to cause the system to perform operations comprising:
receiving outgoing payment information for a user unit account of a user account owner, the outgoing payment information comprising an outgoing amount of a fiat currency that is to be credited to a banking account of the user account owner at a banking institution type of third party financial institution;
determining an exchange rate, the exchange rate describing a number of Indivisible Physical Identifiable Currency Units having a value equal to the outgoing amount of the fiat currency based on an exchange rate between the fiat currency and Indivisible Physical Identifiable Currency Units;
transferring ownership of a number of Indivisible Physical Identifiable Currency Units, the number equal to the exchange rate, from the user unit account to a system unit account by generating a transaction record in the digital ledger, wherein the transaction record simultaneously disassociates the identifiers of the number of Indivisible Physical Identifiable Currency Units from the user unit account and associates the identifiers of number of Indivisible Physical Identifiable Currency Units with the system unit account; and
debiting the outgoing amount of the fiat currency from a system fiat settlement account and crediting the outgoing amount of the fiat currency to the banking institution type of third party financial institution.

20. The system of claim 19, wherein the identifier of each Indivisible Physical Identifiable Currency Unit is physically affixed to that Indivisible Physical Identifiable Currency Unit, and wherein at least one Indivisible Physical Identifiable Currency Unit comprises one of a gold bullion coin and a gold bullion bar.
